(19) United States
(12) Patent Application Publication
(10) Pub. No.: US 2008/0078615 A1
(43) Pub. Date: Apr. 3, 2008

(54) WALKING LADDER

(76) Inventor: Sidney B. Fowlds, West Vancouver (CA)

Correspondence Address: VERMETTE & CO., SUITE 320 - 1177 WEST HASTINGS STREET, VANCOUVER, BC, V6E2K3, US

(21) Appl. No.: 11/537,909

(22) Filed: Oct. 2, 2006

(51) Int. Cl. E06C 1/00

(52) U.S. Cl. 182/163; 182/194

(57) ABSTRACT

A walking ladder which has a pair of ladder sections each section having a pair of spaced apart elongated members and a series of steps spaced apart and extending across the space between the elongated members. A pair of hinges are provided with each hinge pivotally coupling corresponding ends of the elongated members so that said sections have an A-shape when in an operating position. The hinges are confined to a width bounded by sides of the elongated members. A user straddles the walking ladder and removes his/her weight from one step and transfers it to another enabling the user to move one section of the ladder relative to the other and hence walk.

### FIELD

The present invention relates to a step ladder that can be moved or walked by a user while mounted on the ladder.

### BACKGROUND

Painter's who are painting the upper part of a wall or molding frequently have to dismount in order to move the ladder so they can paint the adjacent region of the wall or molding. In addition, after dismounting they also have to remove the paint to avoid spilling it while moving the ladder. There are small scaffolds that can be employed using either two ladders, one on either end, or other types of supports. However, moving such scaffolds is time consuming and complicated.

Accordingly, there is a need for a simple ladder structure that can easily and conveniently be moved or walked by a user.

### SUMMARY OF THE INVENTION

According to the invention there is provided a ladder which has a pair of ladder sections each section having a pair of spaced apart elongated members and a series of steps spaced apart and extending across the space between the elongated members. A pair of hinges are provided with each hinge pivotally coupling corresponding ends of the elongated members so that the sections have an A-shape when in an operating position. The pair of sections can be pivoted towards and away from each other by a user straddling the sections causing the ladder to walk, the hinges being confined to a width bounded by sides of the elongated members.

The hinges may have square openings and include a square elongated element slidably insertable through said square openings and operative to support a handle of a can of paint.

The top two steps of each section may be aligned along a length of the elongated members so as to provide more comfort to a user.

The second steps of said sections which support a user are adjustable to be horizontal in one position and inclined downwardly 12.5 degrees towards the center in another position.

The hinges may each have a pair of opposed elements attachable to a top of corresponding elongated members with one element having a spaced apart pair of plates with a square hole through each of the plates and a single plate on another of the elements with a square hole alignable with the square holes through the pair of plates and arcuate slots through the single plate alignable with holes in the pair of plates thereby allowing pivotal movement of the single plate relative to the pair of plates.

The bottom step of the sections may have a horizontal top surface.

The second step immediately above the bottom step on each of the sections may advantageously be rotatable from having a level top surface to one 12.5 degrees downwardly towards an inside of the walking ladder.

The walking ladder may have a holder insertable in the square holes and a locking mechanism preventing the holder from sliding out of the square holes.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a perspective view of a user straddling the ladder with a bucket of paint supported by a square section of tube stock;

FIG. 2 is a perspective view of the ladder with a square length of tube stock inserted in one of its hinges;

FIG. 3 is an exploded perspective view of one of the hinges;

FIG. 4 is an assembled perspective view of the hinge of FIG. 3;

FIG. 5 is a front elevation view of the hinge of FIG. 3;

FIG. 6 is perspective view of one of the two steps upon which a user rests his feet;

FIG. 7 is a side elevation view of the step of FIG. 6;

FIG. 8 is an end view of one of the four top vertically aligned steps.

### DETAILED DESCRIPTION WITH REFERENCE TO THE DRAWINGS

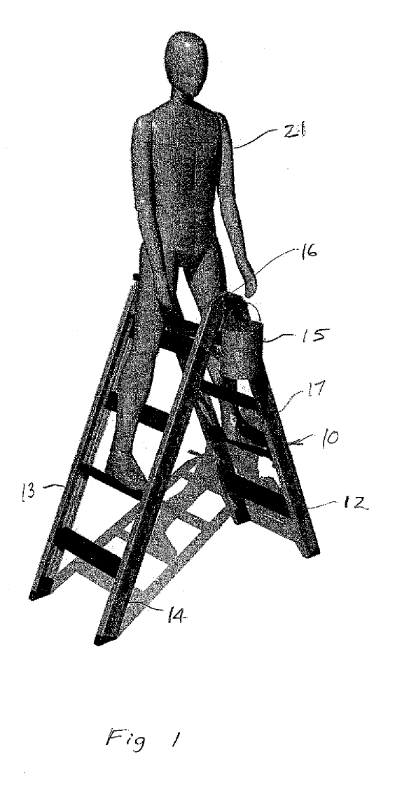

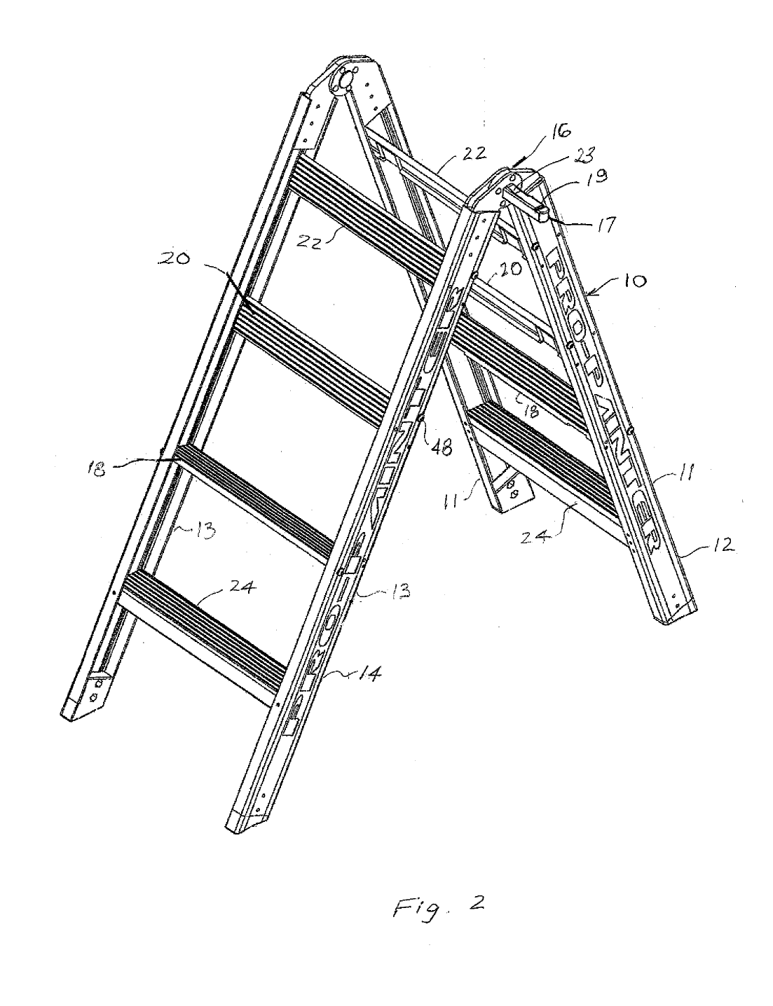

Referring to FIG. 1, the ladder 10 has two sections 12 and 14 pivotally joined at the top by two hinges 16. A user 21 steps on the second step on each section and straddles the central region. In order to move the ladder 10, the user 21 takes his weight off of one of the two steps and drags the corresponding one of sections 12 and 14 towards the other. Then he takes the weight off of his other leg and pushes the other of sections 12 and 14 away. This process is repeated causing the ladder 10 and user 21 to walk to the left or to the right of the user. A more detailed view of the ladder 10 is seen in FIG. 2. The lower step 24 on each section 12 and 14 is mounted so that its top surface is horizontal. The second step 18 is adjustable from having a horizontal step surface to one in which the step surface is inclined downwardly by 12.5 degrees towards the center of the ladder 10. With both steps 18 so inclined, the user 21 is in a more comfortable position in standing and moving the ladder 10. The top four steps 20 and 22 are for support and balance and mounted so they are aligned with the longitudinal direction of each section 12 and 14. These steps do not interfere with the user's legs and assist the user when movement of the ladder legs is required. Bolts 48 pass through holes in a elongated member 13 and 11 of each section 12 and 14 of the ladder 10 and engage a threaded hole 46 in each step 20 and 22 (see FIG. 8). A square plastic paint can holder 17 (see FIG. 2) is inserted through a square hole in one of the hinges 16 until a locking spring 23 opens and blocks removal. A groove 19 holds the handle of a paint can 15 (see FIG. 1).

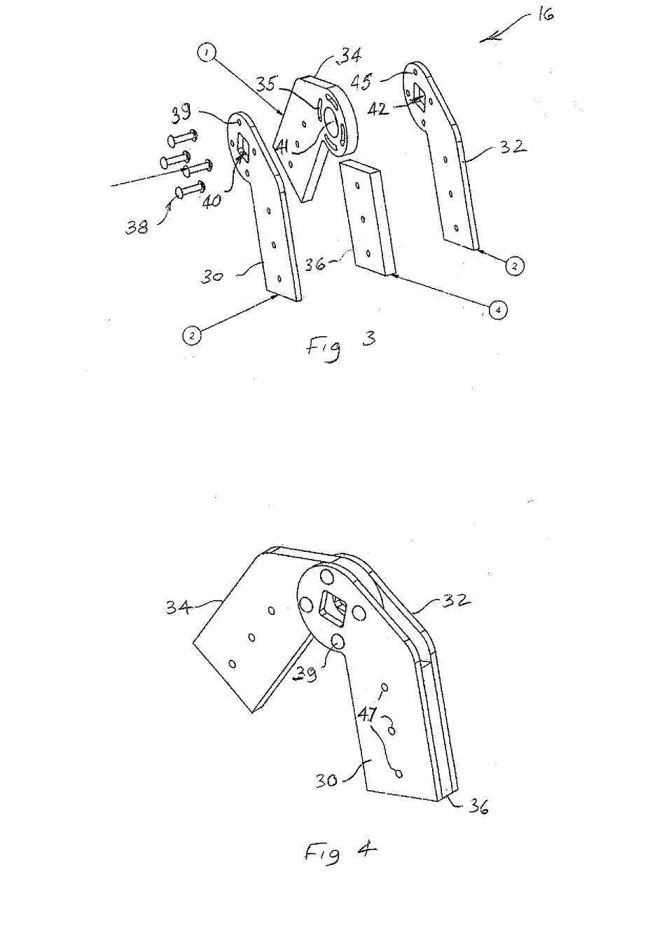

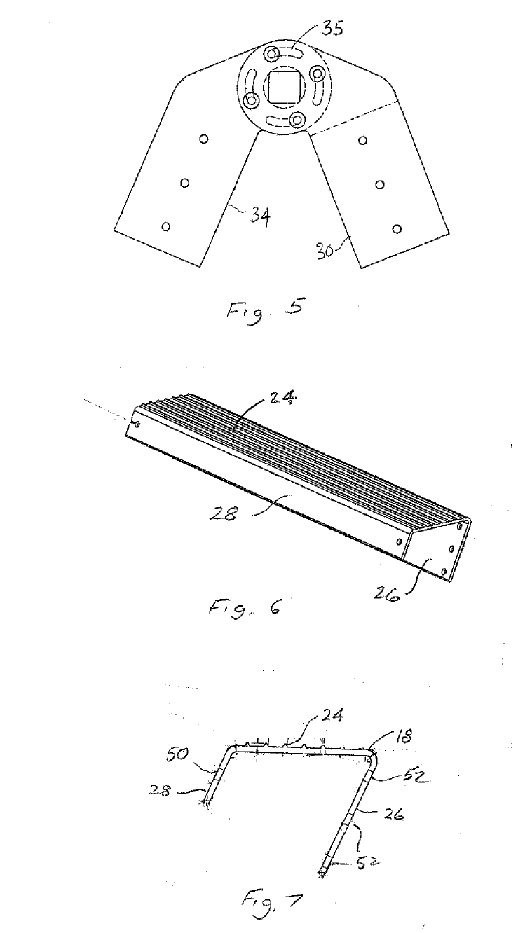

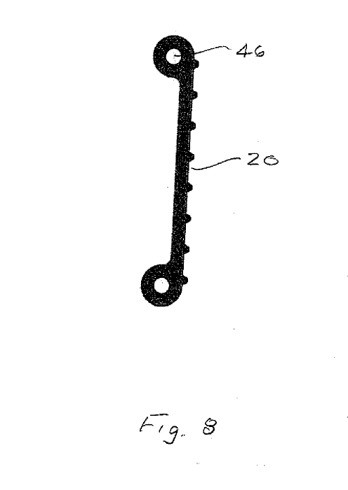

Referring to FIGS. 3, 4, and 5, each hinge 16 is made up of two side plates 30 and 32 having square holes 40 and 42, respectively. A central plastic block 36 fits between plates 30 and 32 and prevents them from binding. An arm 34 has a portion which also fits between plates 30 and 32 and a central hole 41 which aligns with square holes 40 and 42. Radially spaced around hole 41 are four arcuate slots 35. Rivets 38 pass through holes 39 in plate 30, through arcuate slots 35 and holes 45 in plate 32 to hold the structure together as shown in FIGS. 4 and 5. The arcuate slots 35 permit up to 45 degrees of rotation.

Referring to FIG. 6 the structure of step 24 consists of a short downwardly depending front plate 28 and a longer downwardly depending rear plate 26. The step 24 is attached by bolts through the legs of each section and through plates 28 and 26.

By utilizing two hinges 16 at either side of the ladder to pivot the ladder, one avoids the presence of a mechanical structure located beneath the groin which could easily pinch the groin area of a user.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description.

I claim:

1. A walking ladder, comprising:
(a) a pair of ladder sections each section having a pair of spaced apart elongated members and a series of steps spaced apart and extending across the space between said elongated members; and
(b) a pair of hinges, each hinge pivotally coupling corresponding ends of said elongated members so that said sections have an A-shape when in an operating position, and said pair of sections can be pivoted towards and away from each other by a user straddling said sections causing said ladder to walk, said hinges being spaced apart a distance equal to a distance between inside surfaces of sides of said elongated members.

2. A walking ladder according to claim 1, wherein said hinges have square openings and including a square elongated element slidably insertable through said square openings and operative to support a handle of a can of paint.

3. A walking ladder according to claim 1, wherein a top two steps of each section are aligned along a length of said elongated members.

4. A walking ladder according to claim 1, wherein third steps from a top of said sections supporting a user are adjustable to be horizontal in one position and inclined downwardly 12.5 degrees towards the center in another position.

5. A walking ladder according to claim 1, wherein said hinges each have a pair of opposed elements attachable to a top of corresponding elongated members with one element having a spaced apart pair of plates with a square hole through each of said plates and a single plate on another of said elements with a square hole alignable with the square holes through said pair of plates and arcuate slots through said single plate alignable with holes in said pair of plates thereby allowing pivotal movement of said single plate relative to said pair of plates.

6. A walking ladder according to claim 1, wherein a bottom step of said sections has a horizontal top surface.

7. A walking ladder according to claim 1, wherein a second step immediately above said bottom step on each of said sections is rotatable from having a level top surface to one 12.5 degrees downwardly towards an inside of said walking ladder.

8. A walking ladder according to claim 5, including a holder insertable in said square holes and having a locking mechanism preventing it from sliding out of said square holes.
